(19) United States
(12) Patent Application Publication
(10) Pub. No.: US 2016/0299834 A1
(43) Pub. Date: Oct. 13, 2016

(54) STATE STORAGE AND RESTORATION DEVICE, STATE STORAGE AND RESTORATION METHOD, AND STORAGE MEDIUM

(71) Applicant: NEC CORPORATION, Minato-ku, Tokyo (JP)

(72) Inventor: Nobuyuki TOMIZAWA, Tokyo (JP)

(21) Appl. No.: 15/035,816

(22) PCT Filed: Dec. 2, 2014
(86) PCT No.: PCT/JP2014/006019

§ 371 Date: May 11, 2016

(30) Foreign Application Priority Data
Dec. 11, 2013 (JP) 2013-256161

(51) Int. Cl. G06F 11/36; G06F 11/14

(52) U.S. Cl. CPC G06F 11/3668; G06F 11/1451; G06F 11/1469; G06F 2201/805; G06F 2201/84

(57) ABSTRACT

To provide a technique that restores and saves execution states faster during software model checking. Described are: a state saving means for saving objects that represent an execution state of software under checking as information representing the execution state by extracting the objects in a memory in a predetermined order of arrangement and copying the objects to a save region; and a state restoring means for restoring the execution state by copying the objects included in the information representing the execution state stored in the save region to a restore region in the memory in the order in which the objects are stored.

### TECHNICAL FIELD

The present invention relates to a technique for saving and restoring execution states of software in software model checking.

### BACKGROUND ART

A technique for performing software model checking by directly executing software is known. Software model checking is a method for checking a software program to be checked by using a model that considers the software program to be a state transition system. In such software model checking, a part of software is directly executed without using a dedicated verification model written in a specialized model description language, and states of a memory before and after the execution are saved. When a plurality of state transitions from a given state are possible in the software model checking, exhaustive execution is repeated in which a state of the memory is restored as needed and then another state transition is made. This makes it easier to find timing-dependent bugs, which are difficult to find in tests or the like. In such software model checking in which software is directly executed, saving and restoring memory states before and after execution of a part of the software are needed to be performed a number of times proportional to the number of state transitions.

NPL 1 describes a related art technique for performing such software model checking. A software model checking system 900 described in NPL 1 is configured as illustrated in FIG. 13.

The software model checking system 900 in FIG. 13 includes the following components: User-defined code storage unit 901, Program execution unit 902, Memory management unit 903, Memory 904, Initial state generation unit 905, State saving and restoration unit 906, States-to-be-searched management unit 907, Transition generation unit 908, Transition execution unit 909, Reached-states management unit 910, Property verification unit 911 and Determining unit 912.

The user-defined code storage unit 901 stores user-defined code of software to be checked.

The program execution unit 902 executes user-defined code and uses the memory management unit 903 to store information to be used during execution in the memory 904. Note that a state of such information in the memory 904 used by the program execution unit 902 will be referred to as “information representing an execution state” of software at the time point.

The memory management unit 903 reserves a required region in the memory 904 in response to a request from the program execution unit 902, manages the use of the region, and releases an unused region to allow the region to be reused.

The memory 904 stores information required during execution by the program execution unit 902.

The initial state generation unit 905 generates (provides) the first state of information used when user-defined code is executed by the program execution unit 902 (an initial state) in the memory 904. The initial state generation unit 905 uses the state saving and restoration unit 906, which will be described later, to save the initial state and places the initial state in a search queue, which will be described later.

The state saving and restoration unit 906 converts information representing an execution state in the memory 904 into a predetermined format and saves the information. The save location is a region reserved in the memory 904. The state saving and restoration unit 906 also converts stored information representing an execution state and restores the converted information into the memory 904.

The states-to-be-searched management unit 907 manages a search queue that holds execution states that are needed to be searched in the order of search. The search queue may be a queue of the starting addresses of regions in which information representing execution states are saved.

The transition generation unit 908 generates a transition that can be made from an execution state retrieved from the search queue. Specifically, the transition generation unit 908 identifies a program segment such as a process thread that can be executed next from the execution state.

The transition execution unit 909 restores a state of the memory 904 to the execution state retrieved from the search queue and then causes the program execution unit 902 to execute a next transition that can be made from the execution state. Note that the transition that can be made is a state generated by the transition generation unit 908.

The reached-states management unit 910 records a hash value that identifies an execution state representing that a transition has been made (reached) by the transition execution unit 909 as a reached state. The reached-states management unit 910 determines whether the execution state to which the transition is made by the transition execution unit 909 has been reached before, on the basis of whether the hash value of the execution state has already been recorded.

When the execution state after the transition made by the transition execution unit 909 is not the reached state, the property verification unit 911 checks the execution state to see whether the execution state satisfies a predetermined property. The property verification unit 911 places information representing the execution state that satisfies the predetermined property in the search queue.

If the execution state after the transition made by the transition execution unit 909 does not satisfy the predetermined property, the determination unit 912 reports the fact as an error. Further, if the transition generation unit 908 cannot find a transition that can be made from the current execution state, the determination unit 912 determines that a deadlock error has occurred.

The software model checking system 900 thus configured according to the related art technique operates as follows.

First, the initial state generation unit 905 creates a memory region that is equivalent to the initial state of software to be checked and places information representing the initial state in a search queue.

Then, the transition generation unit 908 retrieves one execution state from the search queue and sets the execution state as the “current execution state”. The transition generation unit 908 then generates a transition (a program segment such as a process thread) that is possible from the “current execution state”.

Then the state saving and restoration unit 906 returns the execution state in the memory 904 to the “current execution state”.

Then the transition execution unit 909 causes the program execution unit 902 to execute the relevant program segment.

Then the state saving and restoration unit 906 saves the execution state to which the transition has been made.

Then the reached-states management unit 910 determines whether the execution state after the transition has been reached. If reached, the software model checking system 900 repeats the process described above for another transition that can be made from the “current execution state”, starting from the processing by the state saving and restoration unit 906 to return the execution state in the memory 904 to the “current execution state”.

If the execution state after the transition has not been reached and does not satisfy a predetermined property, the property verification unit 911 outputs an error.

If the execution state after the transition has not been reached and satisfies the predetermined property, the property verification unit 911 places the execution state after the transition into the search queue. The reached-states management unit 910 records a hash value to indicate that the execution state has been reached.

The software model checking system 900 then repeats the process described above for another transition that can be made from the current execution state, starting from the processing by the state saving and restoration unit 906 to return the execution state in the memory 904 to the “current execution state”.

Once the process described above has been completed for all transitions that can be made from the current execution state, the software model checking system 900 retrieves the next “current execution state” from the search queue. Then the software model checking system 900 repeats the process described above, starting from the processing by the transition generation unit 908 to generate a transition that can be made from the “current execution state”.

Note that if there is not a transition that can be made from the current execution state, the determination unit 912 outputs a deadlock error.

The software model checking system 900 repeats the entire process described above until the search queue becomes empty.

A software model checking system that directly executes software as described in NPL 1 searches all possible state transitions in software as described above, rather than executing the software on test data (test execution). The test execution here is processing in which test data is provided to software and the software is tested to determine whether the software performs an intended operation on given data, or whether the software does not perform an unintended operation. In contrast, the software model checking system that directly executes software can exhaustively search states that fails by searching all possible state transitions.

### CITATION LIST

### Patent Literature

[NPL1] Madanlal Musuvathi, “CMC: a MODEL CHECKER FOR NETWORK PROTOCOL IMPLEMENTATIONS”, Technical Report PhD Thesis, Stanford University, January 2004.

### SUMMARY OF INVENTION

### Technical Problem

However, the related technique described in NPL 1 has a problem that the technique takes long time for restoring and saving execution states for conducting software model checking. To address this, the related art technique uses a memory protection function of an OS (Operating System) to save only a portion of an execution state for which a state has been newly saved when saving the execution state. Accordingly, it is difficult to apply the related art technique to a more general environment (for example, an environment without a memory protection function or an environment in which a memory protection function cannot be used without restraints, such as an interpreter). Therefore, interconversion with a portable format is usually performed as serialization/deserialization processing of execution states. This adds to the cost of memory object traversal when an execution state is saved. Furthermore, when a saved execution state is restored into a memory, the cost of object traversal and regeneration is increased.

The present invention has been made in order to solve the problems described above. A principal object of the present invention is to provide a technique that restores and saves execution states faster during software model checking.

### Solution to Problem

A state storage/restoration device of the present invention includes:

a state saving means for saving objects that represent an execution state of software under checking as information representing the execution state by extracting the objects in a memory in a predetermined order of arrangement and copying the objects to a save region; and

a state restoring means for restoring the execution state by copying the objects included in the information representing the execution state stored in the save region to a restore region in the memory in the order in which the objects are stored.

A state storage/restoration method of the present invention includes:

saving objects that represent an execution state of software under checking as information representing the execution state by extracting the objects in a memory in a predetermined order of arrangement and copying the objects to a save region; and

restoring the execution state by copying the objects included in the information representing the execution state stored in the save region to a restore region in the memory in the order in which the objects are stored.

A storage medium and a computer program therein of the present invention for causing a computer to execute:

a state saving step of saving objects that represent an execution state of software under checking as information representing the execution state by extracting the objects in a memory in a predetermined order of arrangement and copying the objects to a save region; and

a state restoring step of restoring the execution state by copying the objects included in the information representing the execution state stored in the save region to a restore region in the memory in the order in which the objects are stored.

### Advantageous Effects of Invention

The present invention provides a technique that restores and saves an execution state faster during software model checking.

### BRIEF DESCRIPTION OF DRAWINGS

FIG. 1 is a functional block diagram of a state storage/restoration device as a first exemplary embodiment of the present invention.

FIG. 2 is a hardware configuration diagram of the state storage/restoration device as the first exemplary embodiment of the present invention.

FIG. 3 is a flowchart illustrating a state saving operation of the state storage/restoration device as the first exemplary embodiment of the present invention.

FIG. 4 is a flowchart illustrating a state restoring operation of the state storage/restoration device as the first exemplary embodiment of the present invention.

FIG. 5 is a functional block diagram illustrating a state storage/restoration device as a second exemplary embodiment of the present invention.

FIG. 6 is a diagram illustrating an exemplary configuration of information representing an execution state saved in the second exemplary embodiment of the present invention.

FIG. 7 is a flowchart illustrating a state saving operation of the state storage/restoration device as the second exemplary embodiment of the present invention.

FIG. 8 is a flowchart illustrating a state restoring operation of the state storage/restoration device as the second exemplary embodiment of the present invention.

FIG. 9 is a diagram illustrating an example of an object reference graph used in the initial state of software under checking in the second exemplary embodiment of the present invention.

FIG. 10 is a diagram illustrating an example of information representing a saved initial state in the second exemplary embodiment of the present invention.

FIG. 11 is a diagram schematically illustrating an operation for saving information representing a current execution state when there is a saved previous execution state in the second exemplary embodiment of the present invention.

FIG. 12 is a diagram schematically illustrating an operation for restoring a saved previous execution state in the second exemplary embodiment of the present invention.

FIG. 13 is a block diagram illustrating a configuration of a software model checking system according to a related art technique.

### DESCRIPTION OF EMBODIMENTS

Exemplary embodiments of the present invention will be described below in detail with reference to the drawings.

### First Exemplary Embodiment

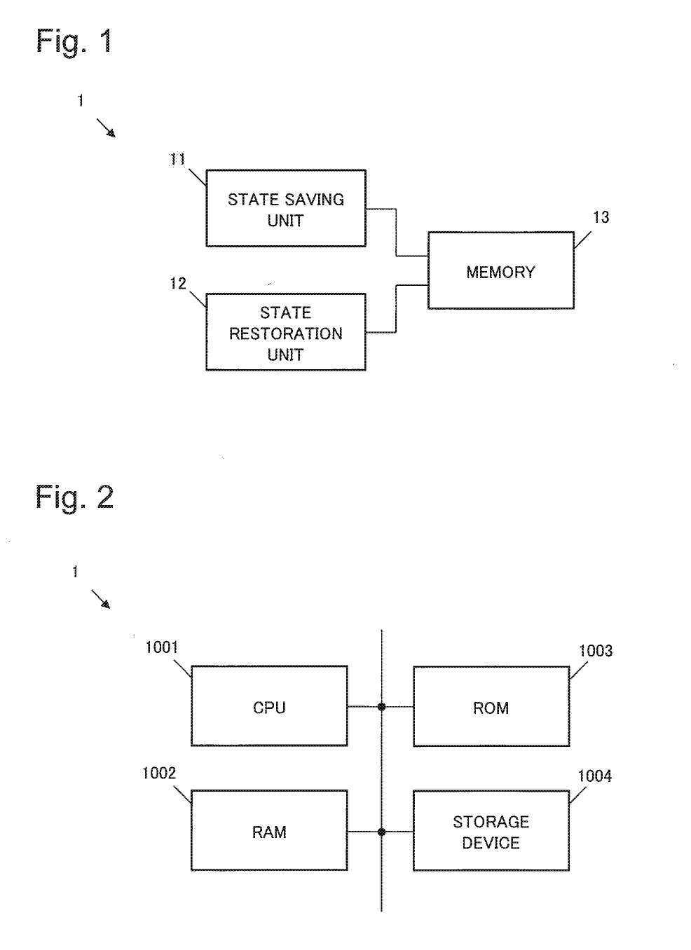

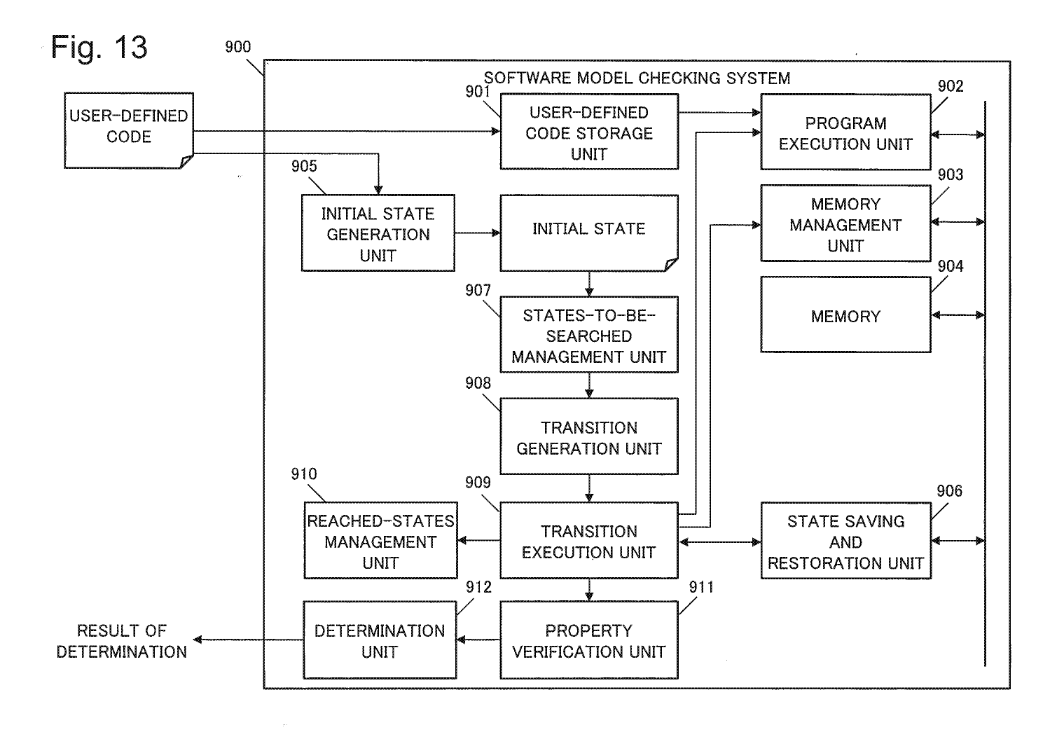

FIG. 1 illustrates a functional block configuration of a state storage/restoration device 1 as a first exemplary embodiment of the present invention. The state storage/restoration device 1 in FIG. 1 includes a state saving unit 11, a state restoration unit 12 and a memory 13. The state storage/restoration device 1 is provided in a software model checking system that directly executes software to search for an execution state transition. For example, the state storage/restoration device 1 may be provided in place of the state saving and restoration unit 906 in the software model checking system 900 of the related art technique illustrated in FIG. 13.

The state storage/restoration device 1 can be implemented by a computer including a CPU (Central Processing Unit) 1001, a RAM (Random Access Memory) 1002, a ROM (Read Only Memory) 1003, and a storage device 1004 such as a hard disk, as illustrated in FIG. 2. Note that the state storage/restoration device 1 may be implemented by a computer that constitutes a software model checking system including the state storage/restoration device 1. In that case, the memory 13 is implemented by the RAM 1002 and the storage device 1004. The state saving unit 11 and the state restoration unit 12 are implemented by the CPU 1001, which loads a computer program and various kinds of data stored in the ROM 1003 and the storage unit 1004 into the RAM 1002 and executes the computer program. It should be noted that the hardware configuration of the state storage/restoration device 1 and its functional blocks are not limited to the configuration described above.

The memory 31 includes a region for storing objects used by software subjected to software model checking (software under checking) during execution of the software. In this exemplary embodiment, objects stored in the memory 13 and used by software under checking are considered to represent the execution state of the software under checking at the time point. The objects in the memory 13 are updated as appropriate as a result of the execution of at least a part of the software under checking.

Note that the memory 13 may store information representing an execution state that is saved by the state saving unit 11, which will be described later, in addition to the objects used by software under checking. However, the term “objects in the memory 13” in the following description of exemplary embodiments of the present invention refers to objects used in the memory 13 in a given execution state of software under checking.

The state saving unit 11 extracts objects that represent the current execution state of software under checking from the memory 13 in a predetermined order of arrangement and copies the objects to a save region (not depicted), thereby saving the objects as information representing the execution state. The save region may be reserved in the memory 13 as mentioned above.

The state restoration unit 12 copies information representing the execution state stored in the save region to a restore region (not depicted) in the memory 13 in the order in which the information is stored, thereby restoring the execution state. The restore region is used by the software under checking for a transition to the next execution state.

Operations of the state storage/restoration device 1 thus configured will be described with reference to the drawings.

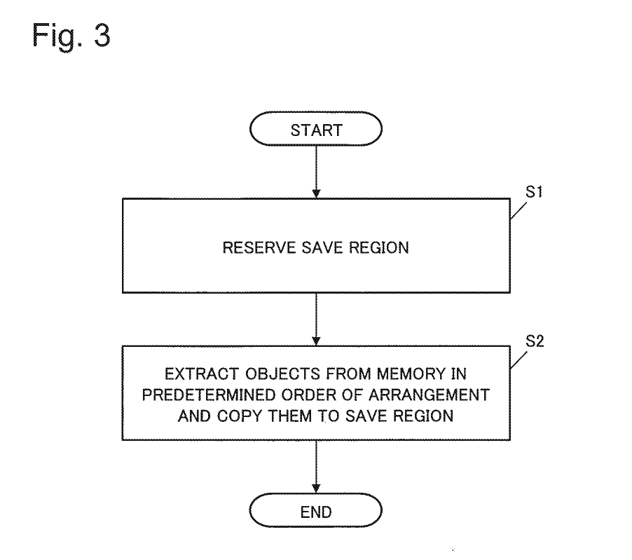

FIG. 3 illustrates a state saving operation of the state storage/restoration device 1.

In FIG. 3, first the state saving unit 11 reserves a continuous save region for saving the current execution state in the memory 13 (step S1).

The state saving unit 11 then traverses objects in the memory 13 used in the current execution state of software under checking in a predetermined order of arrangement to extract the objects and copies the extracted objects to the save region (step S2).

With this, the state storage/restoration device 1 ends the state saving operation.

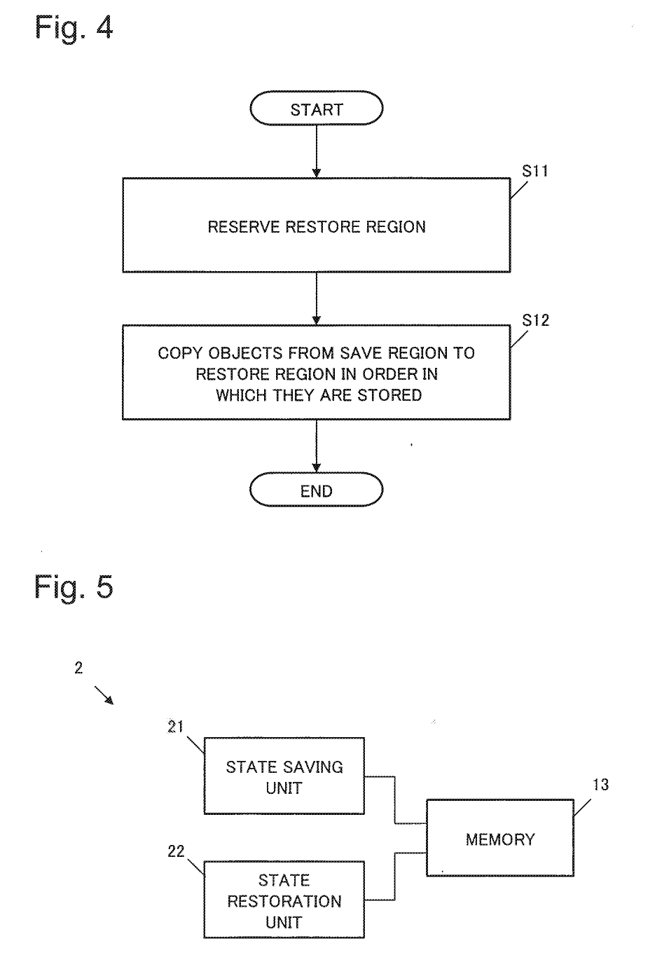

FIG. 4 illustrates a state restoring operation of the state storage/restoration device 1.

In FIG. 4, first the state restoration unit 12 reserves a continuous restore region in the memory 13 for restoring an execution state (step S11).

The state restoration unit 12 then sequentially copies to the restore region the objects included in information representing the execution state stored in the save region in the order in which the objects are stored (step S12).

With this, the state storage/restoration device 1 ends the state restoring operation.

Advantageous effects of the first exemplary embodiment of the present invention will be described below.

The state storage/restoration device 1 of the first exemplary embodiment of the present invention is capable of restoring and saving execution states faster during software model checking.

This is because the state saving unit copies objects that represent an execution state of software under checking in the memory to a save region in a predetermined order of arrangement to save the execution state. Another reason is that the state restoration unit copies information representing the saved execution state to a restore region in the order in which the information is stored to restore the execution state.

The state storage/restoration device 1 according to this exemplary embodiment performs the following process to save an execution state to which a transition has been made from a restored execution state. The state storage/restoration device 1 sequentially copies unchanged objects arranged in the memory generally in a predetermined order of arrangement to a save region in that order. Further, the state storage/restoration device 1 according to this exemplary embodiment restores the objects held successively in the save region into a restore region in the same order. According to this exemplary embodiment, therefore, objects stored in the memory can be copied generally in the order in which the objects are arranged in the memory when saving and restoring the execution state. Accordingly, the state storage/restoration device 1 according to this exemplary embodiment performs saving and restoration faster than a device that performs saving and restoration by conversion with a portable format. In addition, the state storage/restoration device 1 according to this exemplary embodiment is capable of minimizing a decrease in performance which would be caused by random access to the memory, by saving and restoring states in the order in which the states are arranged in the memory as much as possible.

### Second Exemplary Embodiment

A second exemplary embodiment of the present invention will be described next in detail with reference to the drawings. In this exemplary embodiment, an example will be described in which a state storage/restoration device (2) is provided in a software model checking system that uses hash values to manage whether an execution state has been reached.

In a software model checking system as illustrated in the Background Art, the number of states is huge or virtually infinite. Therefore, an approach that uses hash values to manage whether a state has been reached is widely used. In general, the probability of hash collision tends to be low. Ignoring the probability of hash collisions, a determination of whether a state has been reached can be done as follows: hash values of memory contents, representing states, are calculated and recorded in advance, and then the determination is made as to whether the hash value about searched state is already recorded. This approach can significantly save memory as compared with saving an entire memory content representing each state to manage whether states have been reached. The approach, called bitstate hashing and hash-compact, is widely known. On the other hand, the approach requires traversal of all of the objects in the memory that constitute a state in order to calculate the hash value. Further, the approach requires calculating the hash values for objects in the memory without being affected by the specific locations of the objects. In this exemplary embodiment, an example will be described in detail in which the state storage/restoration device (2) reduces the cost of calculation of hash values to further increase the speed of saving and restoration of execution states. In the drawings referred to in the description of this exemplary embodiment, the same components as those of the first exemplary embodiment of the present invention and steps that operate in the same way as steps in the first exemplary embodiment are given the same reference numerals and detailed description of those components and steps will be omitted from the description of this exemplary embodiment.

FIG. 5 illustrates a configuration of the state storage/restoration device 2 according to the second exemplary embodiment of the present invention. In FIG. 5, the state storage/restoration device 2 differs from the state storage/restoration device 1 of the first exemplary embodiment of the present invention in that the state storage/restoration device 2 includes a state saving unit 21 in place of the state saving unit 11 and a state restoration unit 22 in place of the state restoration unit 12. As noted above, the state storage/restoration device 2 is provided in a software model checking system that uses the hash values to manage whether execution states have been reached when directly executing software under checking to search for execution state transitions. For example, the state storage/restoration device 2 may be provided in a software model checking system 900 according to the related art technique as illustrated in FIG. 13 in place of the state saving and restoration unit 906.

The state storage/restoration device 2 and its functional blocks can be implemented by the same hardware elements as those of the state storage/restoration device 1 of the first exemplary embodiment of the present invention described with reference to FIG. 2. Note that the state storage/restoration device 2 and its functional blocks are not limited to the hardware configuration described above.

The state saving unit 21 extracts objects stored in the memory 13 that represent the current execution state of software under checking in the order in which the objects are stored in the memory 13 and copies the objects to a save region in the memory 13. This process is the same as the process performed by the state saving unit 11 in the first exemplary embodiment of the present invention. When extracting and copying the objects in the order of arrangement, the state saving unit 21 saves meta information concerning the objects in the save region along with the objects. The meta information in this exemplary embodiment includes the hash values for information from the starting object to each of the objects and information representing the depths of the objects from the search starting node (as will be described later in detail). Note that the object sequence from the starting object to the last object in the save region is held in a continuous region. Meta information is held in a region in the save region that is different from the continuous region in which the object sequence is held.

When copying objects in the memory 13 to the save region in the order of arrangement, the state saving unit 21 replaces reference information in each object with an offset from a base address and copies the objects.

When there is a save region in which information representing the previous execution state is stored, the state saving unit 21 compares objects included in the information representing the previous execution state with the objects in the current execution state in the memory 13 while traversing the objects included in the information representing the previous execution state in the order in which the objects are stored. The objects in the current execution state in the memory 13 represent the state after a part of software under checking (for example, one unit of a program) has been executed from the previous execution state restored by the state restoration unit 22, which will be described later. Accordingly, the starting object and unchanged objects that follow the starting object in the current execution state in the memory 13 are arranged in the same order as the corresponding objects included in the information representing the previous execution state. Therefore, for the starting object and unchanged objects that follow the starting object, the state saving unit 21 copies the corresponding objects in the previous execution state and their meta information which is the hash values and information representing the depths, to the save region for the current execution state. In this way, the state saving unit 21 omits calculation of hash values for the starting object and unchanged objects that follow the starting object.

It is assumed in this exemplary embodiment that breadth-first search order based on the reference relationship between objects is used as the order of arrangement. Breadth-first search is a technique used for traversing a tree structure or graph in graph theory and a search algorithm traverses all neighbor nodes, starting from the root node. The above-mentioned depth information included in the meta information is information indicating the depth of an object of interest from the root object (root node) in the breadth-first search order. Assume that, as a result of comparison with objects included in the information representing the previous execution state, the state saving unit 21 detects an object in the memory 13 that has been changed in contents in the current execution state. In this case, the state saving unit 21 does not copy the objects that are located at the same depth as the changed object in the breadth-first search order and deeper from the information representing the previous execution state but extracts objects in the memory 13 while arranging the objects in the breadth-first search order. The state saving unit 21 then copies the extracted objects to the save region. Further, the state saving unit 21 calculates new hash values for the objects at the same and greater depths and stores the hash values in the save region as meta information along with information indicating the depths.

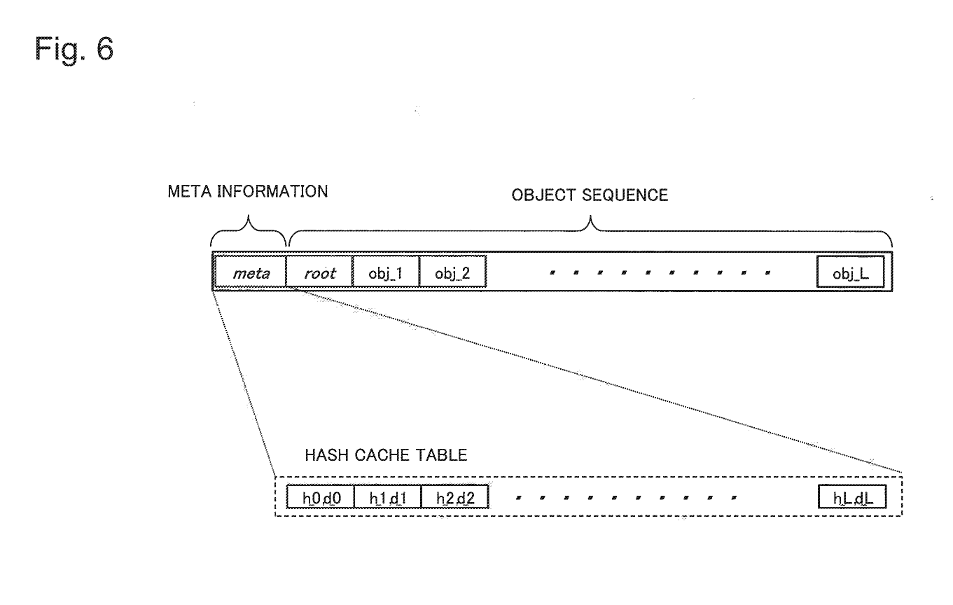

An exemplary configuration of information representing an execution state stored in a save region is schematically illustrated in FIG. 6. In FIG. 6, the information representing the execution state includes an object sequence arranged in a continuous region in the breadth-first search order and meta information. The meta information holds the hash value of each of the objects in the object sequence and information representing the depths of the objects. The hash value is a hash value calculated for information from the starting object (the root object) of the object sequence to an object of interest. Such hash values are interim calculation values for a hash value calculated for information from the root object to the last object. Such the hash value calculated for each object is hereinafter also referred to as an “interim hash value”. The information representing the depth of an object is the depth of the object from the root object in the breadth-first search order. FIG. 6 illustrates a hash cache table representing an example of a data structure of the meta information that holds such interim hash values and information representing depths. The hash cache table is an array including as many elements as the number of objects in an object sequence. An i-th element (i=1, 2, 3, . . . , L) in the hash cache table is information that is a combination of an interim hash value h_i calculated from the root object (root) to the i-th object obj_i and the depth d_i of the object obj_i in breadth-first search order. Because of the nature of hash values, the interim hash value h_i+1 can be calculated by using the interim hash value h_i and the (i+1)-th object obj_i+1. The hash value h_L of the last element thus calculated is equal to the hash value for information that is the entire object sequence arranged in the breadth-first search order from the root object (root) to the last object obj_L.

Like the state restoration unit 12 in the first exemplary embodiment of the present invention, the state restoration unit 22 copies information representing an execution state stored in a save region to a restore region in the memory 13 in the order in which the information is stored to restore the execution state. In doing so, the state restoration unit 22 in this exemplary embodiment replaces reference information replaced with an offset in each object with the offset plus the starting address of the restore region and copies it to the restore region.

Operations of the state storage/restoration device 2 thus configured will be described with reference to the drawings.

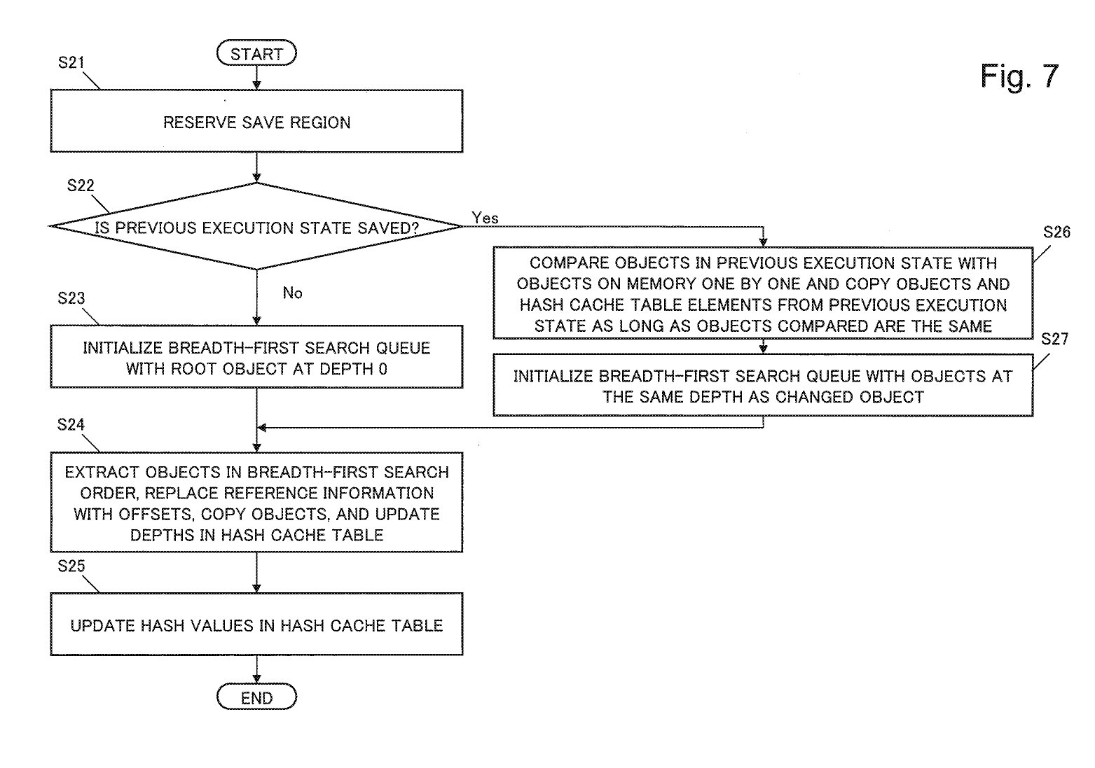

FIG. 7 illustrates a state saving operation of the state storage/restoration device 2.

In FIG. 7, first the state saving unit 21 reserves a save region in the memory 13 for saving an execution state (step S21). In this regard, the state saving unit 21 reserves a continuous region as at least a region for saving an object sequence.

The state saving unit 21 then checks the memory 13 to see whether there is a save region in which information representing a previous execution state is stored (step S22).

For example, there is not information representing a previous execution state immediately after the initial execution state (the initial state) for executing the software model checking has been generated.

In this case, the state saving unit 21 pairs the root object in the memory 13 in the initial state with a depth of 0 to initialize a breadth-first search queue for extracting objects in breadth-first search order (step S23). In other words, in this state, the pair of information representing the root object and a depth of 0 is held in the breadth-first search queue.

The state saving unit 21 places objects referenced by objects extracted from the breadth-first search queue into an object search queue and also copies the extracted objects to the save region. In this regard, if there is reference information in an object, the state saving unit 21 replaces the reference information with an offset from the base address and copies the object to the save region. In addition, the state saving unit 21 updates information representing the depth associated with each element in the hash cache table (step S24).

The state saving unit 21 repeats step S24 to sequentially copies objects in the memory 13 to the reserved save region while extracting the objects in the breadth-first search order by using the breadth-first search queue.

After completion of the copying of the objects by the breadth-first search, the state saving unit 21 traverses the saved objects in the order in which the objects are arranged in the save region to calculate interim hash values from the root object to each of the objects. The state saving unit 21 then updates the hash values for the related elements in the hash cache table (step S25).

When the initial state generated for the first time in software model checking is saved, an entire object sequence in the memory 13 is extracted and saved in the breadth-first search order in this way. The last value in the hash cache table is the hash value for the entire information representing the saved initial state.

On the other hand, after a part of the software under checking has been executed due to a state transition in the process of software model checking, it is determined at step S22 that there is information representing the previous execution state.

In this case, the state saving unit 21 compares the objects included in the saved previous execution state with the objects in the memory 13 in the execution state after the state transition one by one in the order in which the objects are stored. The state saving unit 21 copies an object and the hash cache table element associated with the object from the information representing the previous execution state to the save region for saving the current execution state as long as the comparison shows that the objects are the same (step S26). The phrase “objects compared are the same” at this step means that the compared two objects are identical to each other.

Specifically, for example, if objects are values such as numbers or character strings, the state saving unit 21 compares the values. If objects are containers which can contain other objects, such as arrays or lists, the state saving unit 21 compares saved objects with objects in the memory 13 field by field by field of the containers. If a field represents a reference to another object, the reference in the information representing the previous execution state to the object is represented by an offset from a base address of 0. In this case, the reference in the object in the memory 13 to the object is a pointer. Therefore, in this case, the state saving unit 21 subtracts the address Y of the root object in the memory 13 from the pointer in the object in the memory 13 to obtain an offset and compares the offset with the object included in the previous execution state.

The state saving unit 21 then detects an object among the objects in the memory 13 that is different from the object included in the information representing the previous execution state. The state saving unit 21 then uses objects that are at the same depth as the detected object to initialize the breadth-first search queue (step S27).

An object that is different from the information representing the previous execution state (a changed object) is detected because a part of the program constituting the software under checking has been executed due to a state transition in the process of the software model checking. For purposes of illustration, an object in the memory 13 found to be different from the information representing the previous execution state is denoted by O_H_Diff. An object in the information representing the previous execution state that is associated with O_H_Diff is denoted by O_S_Diff.

Specifically, the information representing the previous execution state includes objects in breadth-first search order. Accordingly, if O_S_Diff and O_H_Diff differ from each other, a change made to O_H_Diff can affect the order of objects that are deeper than O_H_Diff in the breadth-first search order. The objects that are deeper than O_H_Diff in the breadth-first search order can be referred to also by an object that is at the same depth as O_H_Diff and has been extracted before O_H_Diff. The state saving unit 21 therefore refers to the hash cache table to identify objects at the same depth d as O_H_Diff in the breadth-first search order and the order of the objects. The state saving unit 21 then uses the objects at the same depth d in that order as initial values in the breadth-first search queue to initialize the breadth-first search queue. An object found in the breadth-first search queue thus initialized may have been altered from the previous execution state or the relative position in the memory 13 may have been changed due to an alteration.

The state saving unit 21 uses the breadth-first search queue thus initialized with the objects at a changed depth to execute step S24 described above. Specifically, the state saving unit 21 places each object referred to by an object retrieved from the breadth-first search queue into the breadth-first search queue and also copies the retrieved object to the save region. In addition, the state saving unit 21 converts reference information to offsets and updates information representing the depths in the hash cache table.

After completion of copying of the objects by the breadth-first search, the state saving unit 21 executes step S25 described above. Specifically, the state saving unit 21 obtains an interim hash value from the root object to each object while traversing the saved objects in the order in which the objects are arranged in the save region. However, for the root object and unchanged objects that follow the root object, interim hash values have already been copied to the values associated with elements in the hash cache table at step S26. Accordingly, the state saving unit 21 needs only to calculate interim hash values for the object that has been changed and the objects that follow the changed object and update the related elements in the hash cache table.

In this way, when an execution state after a state transition is saved in the process of software model checking, objects among the objects in the memory 13 that have not changed from the previous execution state are copied from information representing the previous execution state. Further, an object at the same depth as an object that has been changed and the objects that follow the object are arranged anew by breadth-first search, extracted from the memory 13 and saved. The last value in the hash cache table is the hash value of the entire information representing the execution state after the state transition.

With this, the state storage/restoration device 2 ends the state saving operation.

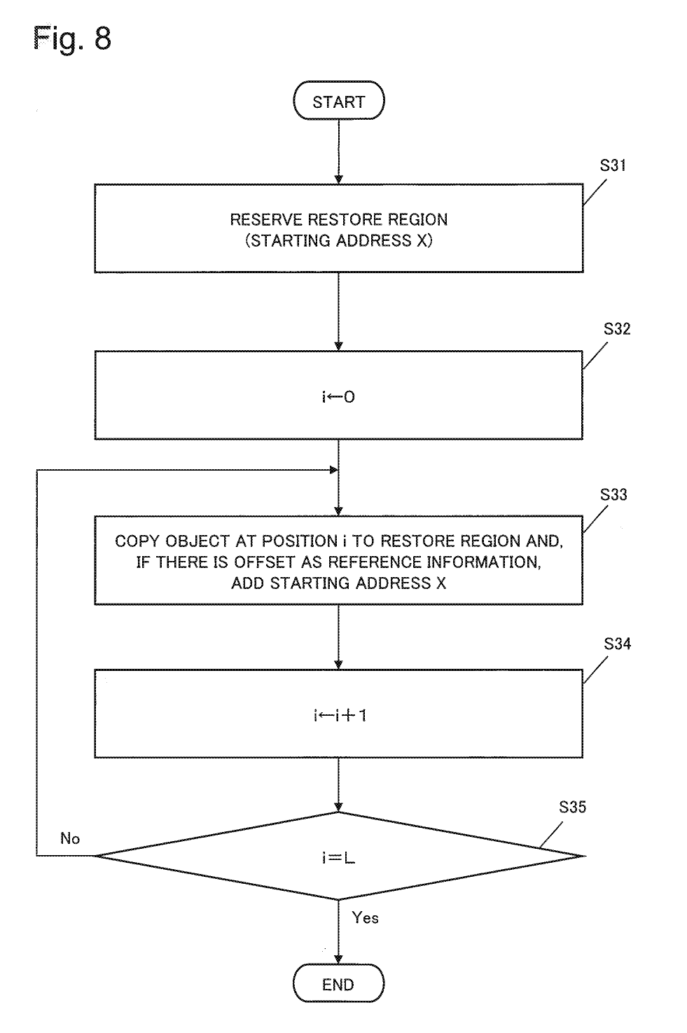

FIG. 8 illustrates a state restoring operation of the state storage/restoration device 2.

In FIG. 8, first the state restoration unit 22 reserves a continuous restore region in the memory 13 (step S31). For example, the state restoration unit 22 may refer to information representing the previous execution state to be restored and reserve a continuous restore region having a size greater than or equal to the size L of the object sequence. For purposes of illustration, the starting address of the restore region is denoted by X.

The state restoration unit 22 then initializes the relative position i of an object with 0 (step S32).

The state restoration unit 22 then writes the object at the relative position i in the information representing the previous execution state back to the restore region in the memory 13 (step S33). If the object to be written back is a value such as a number or a character string, the state restoration unit 22 directly copies the value to the restore region. If the object to be written back is a container which can contain other objects, such as an array or a list, the state restoration unit 22 adds the starting address X of the restore region to offsets which are references to the other objects contained in the container. It is assumed that when the state restoration unit 22 adds the starting address X to the offsets, the state restoration unit 22 also performs the process for copying each field of the container to the restore region. As a result, the references to the objects represented by the offsets from a base address of 0 in the information representing the previous execution state saved are converted to pointer values based on the starting address X of the restore region reserved in the memory 13.

The state restoration unit 22 then adds 1 to the relative position i to update the relative position (step S34).

When i becomes equal to the size L of the object sequence included in the information representing the previous execution state (Yes at step S35), the state restoration unit 22 ends the restoring operation.

When i is less than the size L of the object sequence, the state restoration unit 22 repeats the operation from step S33 in order to restore the next object.

Then the state storage/restoration device 2 ends the state restoring operation.

An example of the operation of the state storage/restoration device 2 will be described next.

It is assumed in this example that information representing an execution state stored in a save region has the structure described above and illustrated in FIG. 6.

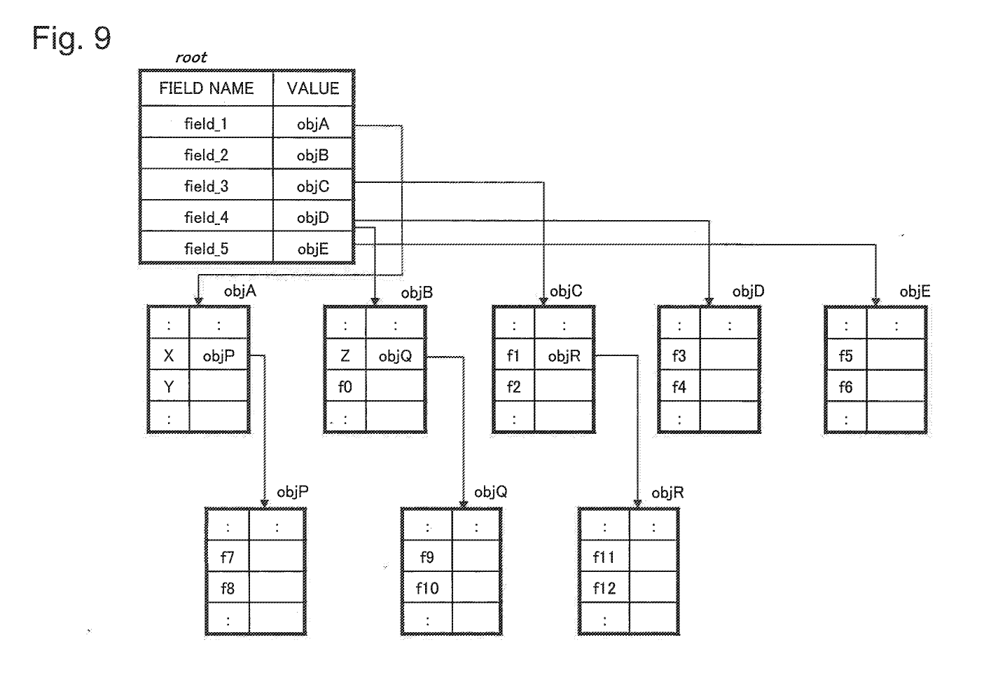

FIG. 9 illustrates a portion of a reference graph of objects in the memory 13 that are used by software under checking in an initial state in this example. In FIG. 9, the root object “root” refers to object objA, object objB, object objC, object objD, and object objE. Object objA refers to object objP. Object objB refers to object objQ. Object objC refers to object objR. It is assumed in this case that the objects are arranged in the following breadth-first search order: Root object “root”, Object objA, Object objB, Object objC, Object objD, Object objE, Object objP, Object objQ, Object objR.

The state storage/restoration device 2 operates as described below to save an execution state.

The state saving unit 21 reserves a save region for saving the execution state (step S21 of FIG. 7).

The state saving unit 21 then checks to see whether there is a save region in which information representing a previous execution state is stored. Since the memory 13 is in the initial state, there is not information that represents a previous execution state (No at step S22).

The state saving unit 21 therefore initializes a breadth-first search queue with a set of the object “root” that is the root object in the memory 13 in the initial state and a depth of 0 (step S23).

While referring to objects in the breadth-first search queue, the state saving unit 21 extracts objects in the breadth-first search order and copies the objects to the save region reserved at step S21. In doing so, the state saving unit 21 replaces reference information (a pointer) in each object that points to another object with an offset from address 0 which is the position of the root object “root” and then copies the object to the save region. In addition, the state saving unit 21 updates depth information associated with each element in the hash cache table (step S24).

If the position of an object in the reference graph of all of the objects to be saved does not change, the offset as the reference to the object is the same regardless of which address the object is located in the memory 13. Accordingly, the state saving unit 21 can save an execution state regardless of actual location addresses in the memory 13 by replacing reference information with offsets.

After completion of copying objects by the breadth-first search, the state saving unit 21 transverses the objects stored in the save region in the order in which they are arranged to obtain interim hash values from the starting object to each object. The state saving unit 21 then updates the hash value information included in each element in the hash cache table with the obtained interim hash values (step S25).

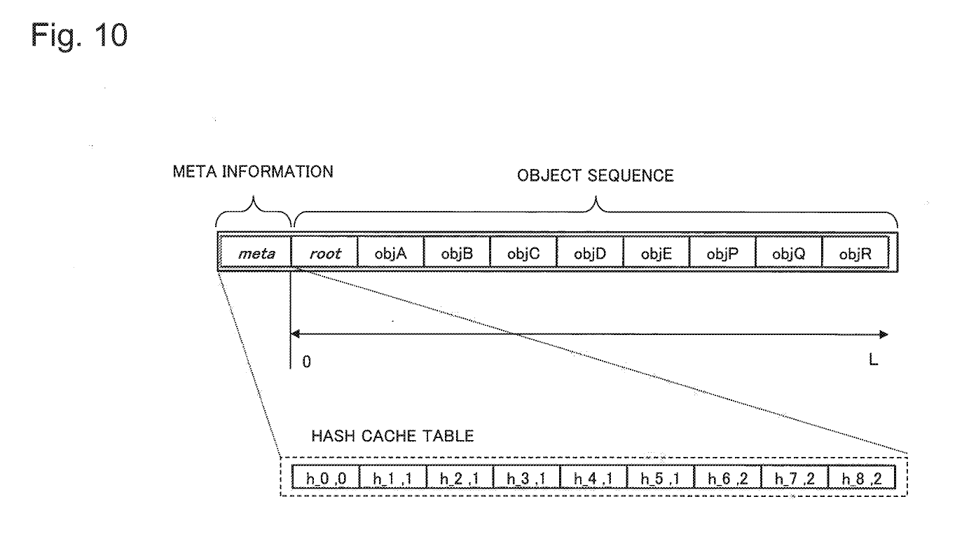

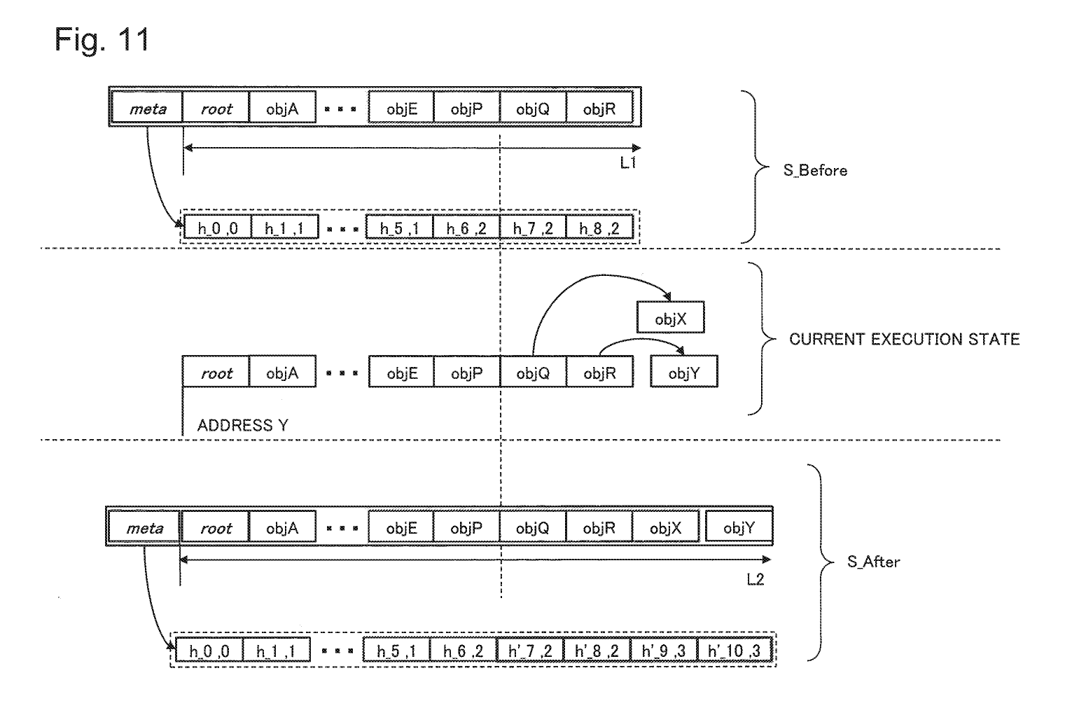

Information representing the initial state first generated in the software model checking has thus been saved. As described above, when the initial state is saved, an entire object sequence in the memory 13 is extracted and saved in the breadth-first search order. Information representing the initial state thus saved in the save region is illustrated in FIG. 10. The root object “root” saved for the root object “root” in the memory 13 is stored at the beginning (address 0) of the object sequence in FIG. 10. The root object “root” is followed by objects objA to objR (address L) sequentially arranged in the breadth-first search order. The hash cache table, which is meta information, contains the same number, eight, of elements as the objects from “root” to objR arranged in the breadth-first search order. Each of the elements is made up of an interim hash value and a depth in the breadth-first search order. For example, the first element <h_0,0> in the hash cache table represents information indicating the hash value h_0 for the root object “root” and a depth of 0. The second element <h_1,1> represents information indicating the hash value h_1 for the byte sequence from the root object “root” to object objA and a depth of 1 in the breadth-first search.

Note that the state saving unit 21 may use any technique to calculate hash values, such as MD5 (Message Digest Algorithm 5), for example. Generally, the hash value h_i+1 from the starting object to an (i+1)-th object can be additively calculated using such a hash function. In the calculation, the hash value h_i from the starting object to the i-th object and the byte sequence of the (i+1)-th object are used. Specifically, for example, the hash value h_2 to object objB can be calculated using the hash value h_1 to object objA and the byte sequence of object objB. The hash value h_8 of the last element of the hash cache table calculated by the additive calculation is the hash value for the entire object sequence saved. The hash value of an entire object sequence is the same if the all objects extracted from the memory 13 and saved and the reference graph between the objects are the same. Accordingly, such a hash value can be used to manage whether the state storage/restoration device 2 has reached an execution state (i.e. how far execution has progressed).

An operation performed by the state storage/restoration device 2 for saving an execution state after the initial state or another execution state thus saved has been restored and then a part of the software under checking has been executed will be described with reference to a schematic diagram in FIG. 11.

In FIG. 11, a save region in which information representing the previous execution state is stored is denoted by S_Before. It is assumed here that objects in the memory 13 that have been restored from S_Before are arranged starting from address Y. Let S_After denote a save region in which a “current execution state” after the part of the software under checking has been executed by using the restored objects in the memory 13 is to be saved anew.

The state saving unit 21 determines that there is a save region S_Before in which information representing the previous execution state is stored (Yes at step S22). In this case, the state saving unit 21 compares the objects contained in S_Before with the objects arranged starting from address Y in the current execution state one by one in the order in which the objects are stored. If objects are values such as numbers or character strings, the state saving unit 21 compares the values. If objects are containers which can contain other objects, such as arrays or lists, the state saving unit 21 compares the objects in S_Before with the objects in the memory 13 field by field of the containers. If a field is a reference to another object, the state saving unit 21 may compare an offset which is the reference to the object in S_Before with a value obtained by subtracting address Y from the pointer value which is the reference to the object in the memory 13.

The objects arranged in the memory 13 starting from address Y are objects that have been placed in a continuous region by the state restoration unit 22. Accordingly, objects in the memory 13 from the starting object to the object that immediately precedes a changed object are information equivalent to the object sequence in S_Before and are arranged in the same breadth-first search order. Therefore, when object-by-object comparison shows that compared objects are equivalent to each other, the state saving unit 21 may directly copy the relevant object in S_Before and the relevant element in the hash cache table to S_After.

The state saving unit 21 compares objects in S_Before with objects in the memory 13 and, as long as the compared objects are the same, copies the objects from S_Before to S_After. Further, the state saving unit 21 copies elements associated with elements in the hash cache table in S_Before to the hash cache table in S_After (step S26).

It is assumed here that as a result of execution of the part of the software under checking, changes have been made from the previous execution state, so that object objQ refers to another object objX and object objR refers to another object objY. In this case, the breadth-first search order of the objects from the root object “root” to object objP which have been found to be the same as a result of the comparison in the breadth-first search order does not change. However, the positions of the objects that follow the object objQ in the breadth-first search order may be changed due to addition, change or deletion. The objects that follow object objQ in the breadth-first search order are searched for only among the objects at the same depth as object objQ in the breadth-first search order. The state saving unit 21 therefore retraverses the objects in the breadth-first search order from the objects at the same depth 2 in the breadth-first search order as object objQ. Specifically, the state saving unit 21 refers to the hash cache table to obtain objects objP, objQ and objR as the objects at the same depth 2 as object objQ that has been changed. The state saving unit 21 uses objects objP, objQ and objR to initialize the breadth-first search queue (step S27).

Subsequently, the state saving unit 21 uses the breadth-first search queue to extract objects in the breadth-first search order and copies the objects to S_After. In addition, the state saving unit 21 converts reference information to offsets and updates depth information associated with elements in the hash cache table (step S24).

After completion of copying of the objects in the breadth-first search order, the state saving unit 21 obtains interim hash values while traversing the objects stored in S_After in the order in which the objects are arranged, and updates the hash cache table (step S25).

At this time point, in S_After, hash values h_0 to h_6 in the hash cache table in S_After that are associated with objects root to objP have been already stored by copying. The state saving unit 21 therefore may calculate the hash value h′_7 from the root object “root” to object objQ from the hash value h_6 for the preceding element in the hash cache table and the byte sequence of object objQ. The state saving unit 21 then repeats the process of calculating the next hash value h′_8 from the hash value h′_7 and the byte sequence of object objR. The state saving unit 21 updates the hash values in the hash cache table to the hash value associated with the last object in S_After. In this way, the state saving unit 21 can calculate the hash value for the entire object sequence stored in S_After simply by calculating interim hash values for the objects that follow the changed object objQ. The hash value is used by the software model checking system that uses this exemplary embodiment for managing whether states have been reached.

With this, the description of the example of the state saving operation ends.

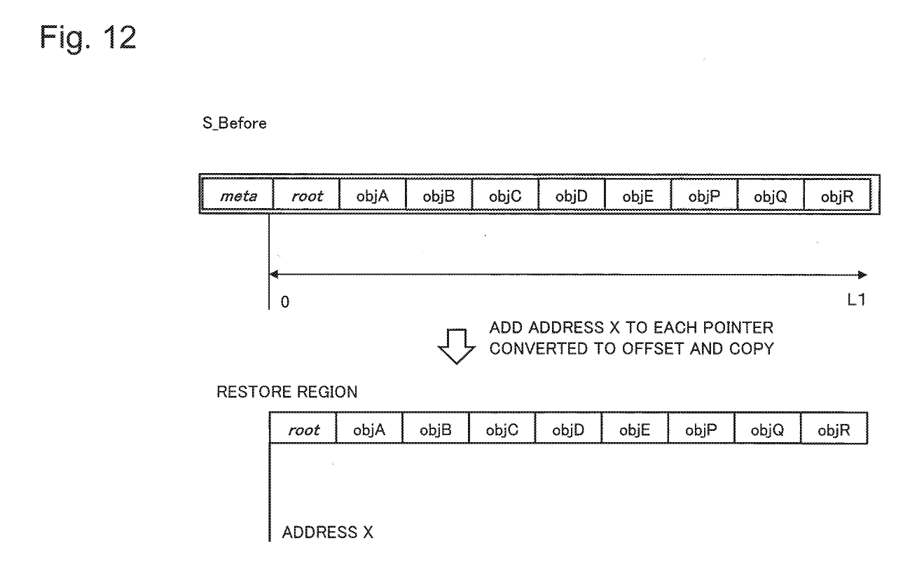

An example of a state restoring operation will be described next with reference to FIG. 12.

It is assumed here that the state restoration unit 22 restores S_Before in FIG. 11.

First, the state restoration unit 22 reserves a continuous region having a size greater than or equal to L1 that is the size of the object sequence contained in S_Before as a restore region in the memory 13 (step S31). Here, let X denote the starting address of the reserved restore region.

The state restoration unit 22 then initializes the relative position i of an object to be restored with 0 (step S32).

The state restoration unit 22 then copies the object at the relative position i in S_Before to the restore region in the memory 13 (step S33). In this case, if the object to be copied is a value, the state restoration unit 22 directly copies the value. If the object to be copied is a container which contains a reference to another object, the state restoration unit 22 adds the starting address X of the restore region to the offset that represents the reference in the object and copies object. The state restoration unit 22 repeats the operation at step S33 to add 1 to each relative position i to update the i until i becomes equal to the size L of the object sequence (L1 in FIG. 12) (steps S34 and S35).

With this, the description of the example of the state restoring operation ends.

Advantageous effects of the second exemplary embodiment of the present invention will be described next.

The state storage/restoration device 2 as the second exemplary embodiment of the present invention is capable of restoring and saving execution states faster by reducing the cost of calculating hash values in software model checking that uses hash values for information representing execution states to manage whether execution states have been reached.

The reasons are as follows. When the state saving unit 21 copies objects in the memory to a save region in a predetermined order of arrangement, the state saving unit 21 calculates a hash value (an interim hash value) for information from the starting object to each object and saves the hash value in the save region along with the object. When there is a save region in which information representing a previous execution state is stored, the state saving unit compares the objects included in the information representing the previous execution state with the objects in the memory 13 in the order in which the objects are stored. During the comparison, the state saving unit 21 copies objects included in the information representing the previous execution state, from the starting object to the object that immediately precedes a changed object, and the interim hash values for the objects to the save region for the current execution state. Further, the state saving unit 21 copies objects included in the information representing the execution state saved in the save region to a restore region in the memory in the order in which the objects are stored to restore the objects.

Because objects in the memory 13 are objects that have transitioned from the previous execution state restored by the state restoration unit 22 in the process of software model checking, the objects are arranged in the memory 13 in about the same order in which the objects are arranged in the information representing the previous execution state. Generally, changes of objects due to one state transition caused by execution of one unit of a program in software model checking are small. The state saving unit 21 therefore may copy the root object and unchanged objects that follow the root object while traversing the objects generally in the order of arrangement in the memory 13, and may extract an object that has been changed and the objects that follow the changed object. Further, the state restoration unit 22 restores objects successively arranged in the save region into the memory 13 in the same order.

This exemplary embodiment is simple because objects can be copied in saving and restoration of a state in the order in which the objects are arranged in the save region or the memory 13 as described above. Accordingly, this exemplary embodiment is capable of minimizing a decrease in performance which would be caused by random access to the memory 13, by performing extraction and restoration of a state in the order in which objects are stored in the memory 13 as much as possible.

Because this exemplary embodiment saves an execution state required for software model checking in a way similar to internal memory form and in a continuous region as described above, this exemplary embodiment is capable of copying the execution state to a continuous region in the memory 13 when restoring the execution state. Therefore, this exemplary embodiment is capable of reducing overhead associated with object regeneration processing and traversal of an object reference graph for the processing.

Further, when objects are extracted from the memory 13 to save an execution state in this exemplary embodiment, an object that is different from information representing the previous execution state is detected and interim hash values are additively calculated for the objects that follow the different object. Specifically, this exemplary embodiment caches interim hash values used for managing whether a state has been reached in software model checking into information representing a saved execution state. Therefore, according to this exemplary embodiment, when an execution state is saved the next time, interim hash values for only a changed portion and the portion that follows the changed portion need to be calculated anew. Accordingly, the cost of hash value calculation is reduced.

Further, since the state restoration unit in this exemplary embodiment restores an execution state into the memory 13 in a way the execution state can be easily extracted by the state saving unit, this exemplary embodiment has the cumulative effect of improving the efficiency of restoring and saving of states and the calculation of hash values for managing whether states have been reached, which can be problematic in software model checking.

The second exemplary embodiment of the present invention has been descried by mainly using examples in which breadth-first search order is used as the order of arrangement of objects to be extracted for saving an execution state. However, in the present invention described above by using the exemplary embodiments, objects may be arranged in any other order. As long as the reference relationship between objects does not change, objects may be arranged in any order of arrangement in which the position of each object is uniquely determined.

The second exemplary embodiment of the present invention has been described by mainly using examples in which meta information included in information representing an execution state is made up of interim hash values and information indicating depths in breadth-first search order. However, the meta information in the present invention described by using the exemplary embodiments may include other information about each object.

While the second exemplary embodiment of the present invention has been described by mainly using examples in which meta information included in information representing an execution state is structured as a hash cache table, information representing an execution state may have any other data structure.

In the second exemplary embodiment of the present invention, particularly, the state saving unit 21 may extract and save objects from a heap and may restore the objects into a heap. The objects in heaps used by software can be reused if the contents of the objects and reference relationships between the objects are correctly restored. Therefore heaps are suitable for saving and restoration according to the present invention. Embodiments of the present invention can use heaps to save and restore information required for state searching in software model checking without unnecessarily increasing the size of information stored as information representing execution states and the time required for saving and restoring the information.

In the exemplary embodiments of the present invention described above, mainly examples have been described in which the functional blocks of the state storage/restoration devices are implemented by a CPU which executes a computer program stored in a storage device or a ROM. However, some or all or a combination of the functional blocks of the present invention described using the exemplary embodiments may be implemented by dedicated hardware.

In the exemplary embodiments of the present invention described above, the functional blocks of the state storage/restoration devices may be implemented as functional blocks distributed among a plurality of devices.

The operations of the state storage/restoration devices described with reference to the flowcharts in the exemplary embodiments may be implemented as a computer program that is stored on a storage device (a storage medium) of a computer and read and executed by the CPU. In that case, the present invention can be considered to be implemented by code representing the computer program or the storage medium on which the code is stored in a computer-readable manner.

The exemplary embodiments described above may be combined and implemented as appropriate.

The present invention has been described with respect to the exemplary embodiments described above as model examples. However, the present invention is not limited to the exemplary embodiments described above. In other words, various modes of the present invention that can be understood by those skilled in the art can be used within the scope of the present invention.

This application is based upon and claims the benefit of priority from Japanese Patent Application 2013-256161 filed on Dec. 11, 2013, the entire disclosure of which is incorporated herein.

### REFERENCE SIGNS LIST

1, 2 State storage and restoration device
11, 12 State saving unit
12, 22 State restoration unit
13 Memory
900 Software model checking system
901 User-defined code storage unit
902 Program execution unit
903 Memory management unit
904 Memory
905 Initial state generation unit
906 State saving and restoration unit
907 States-to-be-searched management unit
908 Transition generation unit
909 Transition execution unit
910 Reached-states management unit
911 Property verification unit
912 Determination unit
1001 CPU
1002 RAM
1003 ROM
1004 Storage device

What is claimed is:

1. A state storage/restoration device comprising:
a state saving unit for saving objects that represent an execution state of software under checking as information representing the execution state by extracting the objects in a memory in a predetermined order of arrangement and copying the objects to a save region; and
a state restoring unit for restoring the execution state by copying the objects included in the information representing the execution state stored in the save region to a restore region in the memory in the order in which the objects are stored.

2. The state storage/restoration device according to claim 1,
wherein when there is a save region in which information representing a previous execution state is stored, the state saving unit compares objects in the memory that represent an execution state after a part of the software under checking has been executed from the previous execution state restored into the restore region by the state restoring unit with objects included in the information representing the previous execution state in the order in which the objects are stored and copies a starting object and unchanged objects that follow the starting object to a save region for saving a current execution state.

3. The state storage/restoration device according to claim 2,
wherein when the state saving unit copies the objects in the memory to the save region in the order of arrangement, the state saving unit stores meta information concerning each of the objects into the save region along with the objects and, if there is a save region in which the information representing the previous execution state is stored, copies the starting one of the objects included in the information representing the previous execution state, unchanged objects that follow the starting object and the meta information associated with the objects to a save region for saving a current execution state.

4. The state storage/restoration device according to claim 3,
wherein when a hash value for the information representing the previous execution state is used to manage whether the execution state has been reached,
the state saving unit calculates as the meta information a hash value for information from the starting object to each object and stores the hash value in the store region and, if there is a save region in which the information representing the previous execution state is stored, copies the starting one of the objects included in the information representing the previous execution state, unchanged objects that follow the starting object, and the hash value associated with the objects to a save region for saving a current execution state, and omits calculation of a hash value of each of the unchanged objects.

5. The state storage/restoration device according to claim 1,
wherein when the state saving unit copies objects in the memory to the save region in the order of arrangement, the state saving unit replaces reference information in each of the objects with an offset from a base address before copying the objects; and
when the state restoring unit copies the objects included in the information representing the execution state stored in the save region to the restore region in the order in which the objects are stored, the state restoring unit replaces an offset as reference information in each of the objects with the offset plus the starting address of the restore region before copying the objects.

6. The state storage/restoration device according to claim 1,
wherein the state saving unit uses breadth-first search order based on a reference relationship between the objects as the order of arrangement.

7. A state storage/restoration method comprising:
saving objects that represent an execution state of software under checking as information representing the execution state by extracting the objects in a memory in a predetermined order of arrangement and copying the objects to a save region; and
restoring the execution state by copying the objects included in the information representing the execution state stored in the save region to a restore region in the memory in the order in which the objects are stored.

8. A non-transitory computer readable storage medium storing a computer program for causing a computer to execute the processing of:
saving objects that represent an execution state of software under checking as information representing the execution state by extracting the objects in a memory in a predetermined order of arrangement and copying the objects to a save region; and
restoring the execution state by copying the objects included in the information representing the execution state stored in the save region to a restore region in the memory in the order in which the objects are stored.

9. The state storage/restoration device according to claim 2,
wherein when the state saving unit copies objects in the memory to the save region in the order of arrangement, the state saving unit replaces reference information in each of the objects with an offset from a base address before copying the objects; and
when the state restoring unit copies the objects included in the information representing the execution state stored in the save region to the restore region in the order in which the objects are stored, the state restoring unit replaces an offset as reference information in each of the objects with the offset plus the starting address of the restore region before copying the objects.

10. The state storage/restoration device according to claim 3,
wherein when the state saving unit copies objects in the memory to the save region in the order of arrangement, the state saving unit replaces reference information in each of the objects with an offset from a base address before copying the objects; and
when the state restoring unit copies the objects included in the information representing the execution state stored in the save region to the restore region in the order in which the objects are stored, the state restoring unit replaces an offset as reference information in each of the objects with the offset plus the starting address of the restore region before copying the objects.

11. The state storage/restoration device according to claim 4,
wherein when the state saving unit copies objects in the memory to the save region in the order of arrangement, the state saving unit replaces reference information in each of the objects with an offset from a base address before copying the objects; and
when the state restoring unit copies the objects included in the information representing the execution state stored in the save region to the restore region in the order in which the objects are stored, the state restoring unit replaces an offset as reference information in each of the objects with the offset plus the starting address of the restore region before copying the objects.

12. The state storage/restoration device according to claim 2,
wherein the state saving unit uses breadth-first search order based on a reference relationship between the objects as the order of arrangement.

13. The state storage/restoration device according to claim 3,
wherein the state saving unit uses breadth-first search order based on a reference relationship between the objects as the order of arrangement.

14. The state storage/restoration device according to claim 4,
wherein the state saving unit uses breadth-first search order based on a reference relationship between the objects as the order of arrangement.

15. The state storage/restoration device according to claim 5,
wherein the state saving unit uses breadth-first search order based on a reference relationship between the objects as the order of arrangement.
